(19) United States
(12) Patent Application Publication
(10) Pub. No.: US 2009/0227341 A1
(43) Pub. Date: Sep. 10, 2009

(54) GAMING SYSTEM AND METHOD OF GAMING

(75) Inventor: John Andrew Curtin, Oyster Bay (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, North Ryde (AU)

(21) Appl. No.: 12/361,288

(22) Filed: Jan. 28, 2009

(30) Foreign Application Priority Data
Jan. 29, 2008 (AU) 2008900383

(51) Int. Cl. A63F 9/24; A63F 13/00

(52) U.S. Cl. 463/20; 463/30; 463/26

(57) ABSTRACT

The present disclosure provides a gaming system which comprises a player symbol selector arranged to select player symbols from a plurality of player symbols. The plurality of player symbols includes at least one special player symbol. The gaming system also comprises a display having a plurality of individual display positions for displaying at least one selected player symbol. Further, the gaming system comprises a display position selector for selecting at least one individual display position prior to displaying a selected player symbol at that display position. The gaming system also comprises a prize allocator for allocating a prize when the at least one special player symbol is displayed at least one selected individual display position.

### CROSS-REFERENCE TO RELATED APPLICATIONS

The present application claims the benefit of priority to Australian Provisional Patent Application No. 2008900383, filed on Jan. 29, 2008, entitled “A GAMING SYSTEM AND A METHOD OF GAMING”, which is herein incorporated by reference in its entirety.

### FIELD OF THE INVENTION

The present invention broadly relates to a gaming system and method of gaming.

### BACKGROUND OF THE INVENTION

Video gaming machines, such as poker or slot machines, are widely used in many countries. Such gaming machines typically have a video display that simulates a number of spinning reels. Each reel has a number of player symbols and a selection of the player symbols is displayed on the display when the simulated reels cease spinning.

The player symbols typically are displayed in an array of display positions on the video display. If the displayed player symbols correspond to a predefined wining combination of player symbols, the player wins a prize. Typically, the winning combination includes two or more of the player symbols displayed along a “win line”, which is a predefined line through adjacent display positions.

In addition, some gaming machines offer the chance to win a Jackpot prize, which typically is a relatively large prize.

### SUMMARY OF THE INVENTION

The present invention provides in a first aspect a gaming system including:

a player symbol selector arranged to select player symbols from a plurality of player symbols, the plurality of player symbols including at least one special player symbol;

a display having a plurality of individual display positions for displaying at least one selected player symbol;

a display position selector for selecting at least one individual display position prior to displaying a selected player symbol at that display position; and

a prize allocator for allocating a prize when the at least one special player symbol is displayed at least one selected individual display position.

The display position selector may be controllable by a player and the gaming system may be arranged so that the player may select the at least one individual display position. Alternatively, the gaming system may be arranged so that the display position selector randomly selects an individual display position from a group of individual display positions upon activation by a player. The gaming system may be arranged so that the selection of the individual display position is associated with a purchase, such as the purchase of a bet.

In one specific embodiment the prize allocator allocates a Jackpot prize when the at least one special player symbol is displayed at least one selected individual display position. Consequently the player has an increased chance to win the Jackpot prize, which may be a progressive Jackpot prize.

In one specific embodiment the gaming system is arranged so that the chance to win the Jackpot prize is proportional to the number of selected individual display positions.

The special player symbol may be displayed at an individual display position in addition to another player symbol displayed at that position. Alternatively, the gaming system may be arranged so that only one player symbol is displayed at each individual display position.

In one example the gaming system is arranged so that a prize is won when a combination of winning player symbols is displayed along a win line, such as along an imaginary horizontal, diagonal or vertical line through adjacent display positions on the display. It is to be appreciated by a person skilled in the art that alternatively the gaming system may also be arranged so that the winning combination may be displayed at another combination of display positions which may not necessarily be oriented along an imaginary line.

The gaming system may be arranged for selecting a plurality of individual display positions along the win line.

The gaming system may be arranged so that the location of the at least one selected individual display position is indicated. For example, the gaming system may be arranged so that the location of the at least one selected individual display position is displayed by displaying a selection indicator at the position of the at least one individual display position or at another position.

The special player symbol and the at least one selection indicator may be associated with each other. For example, the selection indicator may be a keyhole and the special player symbol may be a key.

The display may be arranged to display the selected player symbols in an array of n×m individual display positions. The player symbols may include a plurality of special player symbols.

The present invention provides in a second aspect a method of gaming including:

selecting at least one player symbol from a plurality of player symbols, the plurality of player symbols including at least one special player symbol;

displaying at least one selected player symbol at one of a plurality of individual display positions;

selecting at least one individual display position prior to displaying the selected player symbol; and

allocating a prize when the at least one special player symbol is displayed at least one selected individual display position.

The step of allocating a prize may include allocating a Jackpot prize.

The step of selecting may include selecting the at least one individual display position by a player. Further, this step may include purchasing a selection of the at least one individual display position, for example by purchasing a bet.

Alternatively, the step of selecting may include selecting the at least one individual display position using a selector that randomly selects the at least one individual display position from a group of display positions.

The step of displaying may include displaying the at least one special player symbol at the at least one selected individual display position in addition to another player symbol displayed at that position. Alternatively, the step of displaying may include displaying only one player symbol at each individual display position.

The method may also include the step of selecting at least one win line. The step of selecting may include selecting the at least one individual display position along the at least one selected win line.

The player symbols may include a plurality of special player symbols.

In one specific embodiment the method is conducted so that the chance to win the Jackpot prize is proportional to the number of selected individual display positions.

The step of displaying may include displaying at least one selection indicator that marks the selection of the at least one selected individual display position. The selection indicator may be displayed at the at least one selected individual display position. Alternatively, the selection indicator may be displayed at a position other than that of the at least one selected individual display position.

The special player symbol and the at least one selection indicator may be associated with each other. For example, the selection indicator may be a keyhole and the special player symbol may be a key.

The present invention provides in a third aspect a computer program for instructing a computer and arranged so that, when loaded in the computer, the computer operates as a gaming system in accordance with the first aspect of the present invention.

The present invention provides in a fourth aspect a computer readable medium having a computer readable program code embodied therein for causing a computer medium to operate as a gaming system in accordance with the first aspect of the present invention.

The present invention provides in a fifth aspect a computer that is arranged for operation in accordance with the gaming system as defined by the first aspect of the present invention.

The present invention provides in a sixth aspect a data signal having a computer readable program code embodied therein and that is arranged to operate for causing a computer to operate in accordance with the gaming system of the first aspect of the present invention.

The invention will be more fully understood from the following description of specific embodiments of the invention. The description is provided with reference to the accompanying drawings.

### BRIEF DESCRIPTION OF THE DRAWINGS

FIG. 1 is a diagrammatic block diagram of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network;

FIG. 6 is a flow diagram illustrating a method of gaming in accordance with an embodiment of the present invention; and

FIGS. 7 to 10 are representations of special player symbols displayed by a gaming system in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF SPECIFIC EMBODIMENTS

Specific embodiments of the present invention concern a gaming system which includes a player symbol selector for selecting player symbols including at least one special player symbol. The gaming system also includes a display for displaying the selected player symbol at a plurality of display positions. A display position selector is used to select one or more individual display positions prior to displaying the selected player symbols. A prize allocator is arranged to allocate a prize when the at least one special player symbol is displayed at least one selected individual display position.

In one embodiment, the display position selector is controlled by a player, who may select the individual display positions for a credit purchase. For example, the player may select one or more individual positions along one or more “win lines”, which are imaginary lines through adjacent display positions on the display. If the at least one special player symbol is displayed at least one selected individual display position, a prize is allocated. For example, the prize may be a Jackpot prize.

The gaming system typically is arranged so that the chance to win the Jackpot prize is proportional to the number of selected display positions.

The special player symbol may be a symbol that is displayed at an individual display position in addition to another player symbol that is also displayed at that display position. Alternatively, the gaming system is arranged so that only one player symbol is displayed at each individual display position.

The player symbols may take any suitable form such as representations of dice, cards, dominoes, tiles, shapes or any other type of symbol.

In one example, each selection of the individual display positions includes a visual selection, which is associated with the special player symbols. For example, each selected position may be marked by a key-hole symbol that is located at a selected individual display position and the special player symbols may be provided in the form of key-symbols.

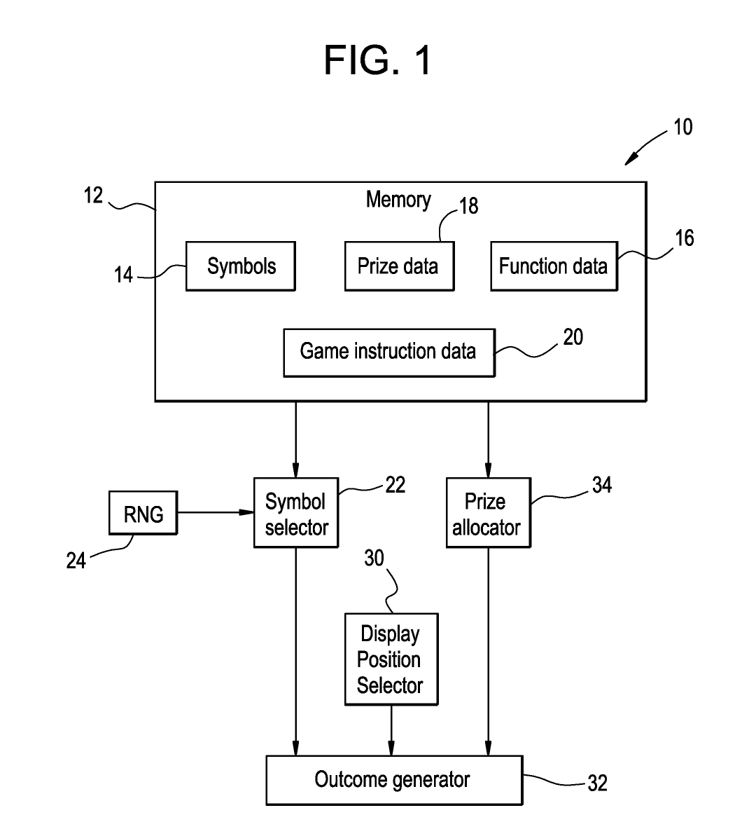

Referring now to FIG. 1, a gaming system according to an embodiment of the present invention is now described. The gaming system 10 includes a memory 12 arranged to store player symbol data 14 indicative of a plurality of player symbols for selection and display to a player during a game, function data 16 indicative of one or more functions associated with one or more of the player symbols, prize data 18 indicative of prize amounts associated with win outcomes for reaching each level of the game, and game instruction data 20 indicative of game instructions usable by the gaming machine 10 to control operation of the game.

The gaming system 10 also includes a player symbol selector 22 which is arranged to select the player symbols for display to a player, in this example using a random number generator 24. The player symbols include at least one special player symbol.

Alternatively, the gaming system 10 may also include a dedicated selector that only selects special player for display to the player. In this case the selector 22 is arranged to select player symbols that are not special player symbols.

It will be appreciated that the random number generator 24 may be of a type which is arranged to generate pseudo random numbers based on a seed number, and that in this specification the term “random” will be understood accordingly to mean truly random or pseudo random.

The gaming system 10 also includes a display position selector 30 that is arranged to select at least one individual display position prior to displaying the player symbols.

The display position selector 30 is in this example controllable by the player. The display position selector 30 is arranged so that the player can choose individual positions for selection, and thereby place bets. In one specific example a bet entitles the player to select display positions. The gaming system 10 is in this case arranged so that the number of display positions that the player may select is dependent on the bet.

Alternatively, the display position selector 30 is arranged to randomly select individual positions for selection once activated by the player by purchasing one or more bets. The display position selector 30 is arranged to provide a visual selection at the selected individual display position, for example in the form of a key-hole symbol.

The display selector 30 is in this example arranged so that the player has the option to select one or more individual display positions prior to each game. Alternatively, the display position selector 30 may be arranged so that the player can still select individual display positions after commencement of a game and before display of the player symbols.

The gaming system 10 also includes a prize allocator 34 which communicates with the prize data 18 stored in the memory 12 and with the selector 30, and determines an appropriate prize to allocate to a player.

Prizes may also be allocated on the basis of occurrence of a particular player symbol, a consecutive sequence such as 1, 2, 3, occurrence of odd or even numbers, occurrence of the same symbol combination and so on.

Instead of providing monetary prize amounts, the prize allocated to a player for reaching a level and/or any additional prize may be in the form of points, tokens, progressive prizes, eligibility for feature games, tournament entitlements, or special symbol entitlements in other games, such as an additional wild symbol for a predefined number of games. For example, if the win is not a Jackpot prize, the win, or a portion thereof, may be contributed to a progressive Jackpot.

In the embodiment described below, the symbol selector 22, the prize allocator 34 and the selector 30 are implemented using a microprocessor and associated programs, although it will be understood that other implementations are envisaged.

The gaming system 10 can take a number of different forms.

In a first form, a stand alone gaming machine is provided wherein all or most components implementing the game are present in a player operable gaming machine.

In a second form, a distributed architecture is provided wherein some of the components implementing the game are present in a player operable gaming machine and some of the components implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

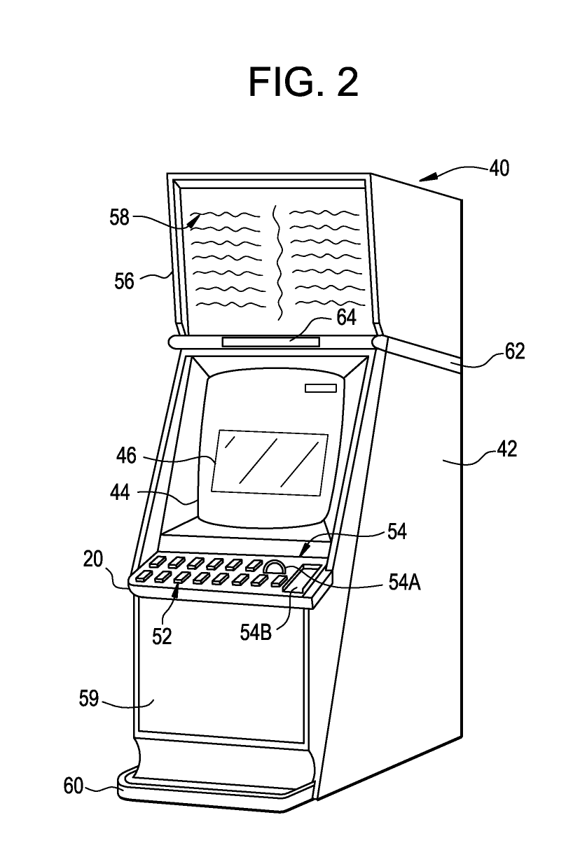

A gaming system in the form of a stand alone gaming machine 40 is illustrated in FIG. 2. The gaming machine 40 includes a console 42 having a display 44 on which is displayed representations of a game 46 that can be played by a player. A mid-trim 50 of the gaming machine 40 houses a bank of buttons 52 for enabling a player to interact with the gaming machine during the game, including enabling the player to select the bet amount and the number of lines. The mid-trim 50 also houses a credit input mechanism 54 which in this example includes a coin input chute 54A and a bill collector 54B. Other credit input mechanisms may also be employed, for example, a card reader for reading a smart card, debit card or credit card.

A top box 56 may carry artwork 58, including for example pay tables and details of bonus awards and other information or images relating to the game. Further artwork and/or information may be provided on a front panel 59 of the console 42. A coin tray 60 is mounted beneath the front panel 59 for dispensing cash payouts from the gaming machine 30.

A player tracking module (PTM) 62 having a display 64 is connected to the gaming machine 40. The main purpose of the PTM 62 is to allow the player to interact with a player loyalty system. The PTM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PTM 62 is a Sentinel III device produced by Aristocrat Technologies Pty Ltd.

In one embodiment, the PTM 62 includes a touch screen and the display 64 of the PTM 62 is used to display the feature game including directional controls used by a player to control movement of an object during the feature game, which movable object may be displayed on the primary or secondary displays 44, 58, or elsewhere.

With this embodiment, the PTM 62 may be arranged to communicate with a remote server such that the status of the feature game including the number of available moves remaining, and the position of each object in the feature game are stored at the remote server and are retrievable by a PTM 62 associated with any gaming machine.

The display 44 is in the form of a video display unit, particularly a cathode ray tube screen device. Alternatively, the display 44 may be a liquid crystal display, plasma screen, any other suitable video display unit. The top box 56 may also include a display, for example a video display unit, which may be of the same type as the display 44, or of a different type.

The display 44 in this example is arranged to display representations of several reels, each reel of which has several associated symbols. Typically 3, 4 or 5 reels are provided.

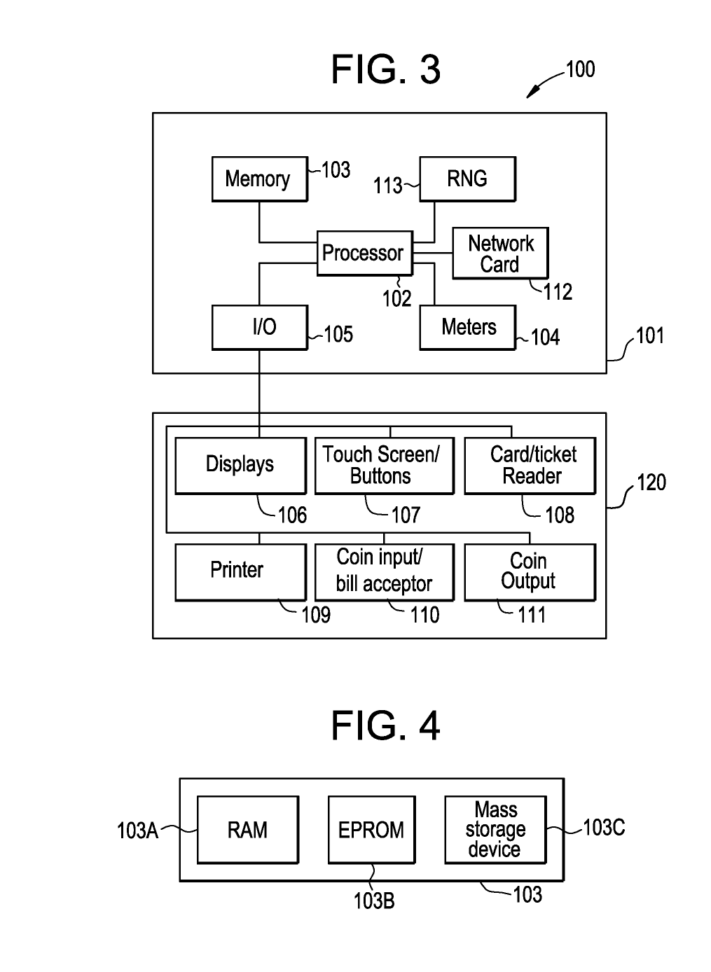

FIG. 3 shows a block diagram of operative components of a typical gaming machine 100 which may be the same as or different to the gaming machine shown in FIG. 2.

The gaming machine 100 includes a game controller 101 having a processor 102. Instructions and data to control operation of the processor 102 are stored in a memory 103 which is in data communication with the processor 102.

Typically, the gaming machine 100 will include both volatile and non-volatile memory and more than one of each type of memory, with such memories being collectively represented by the memory 103.

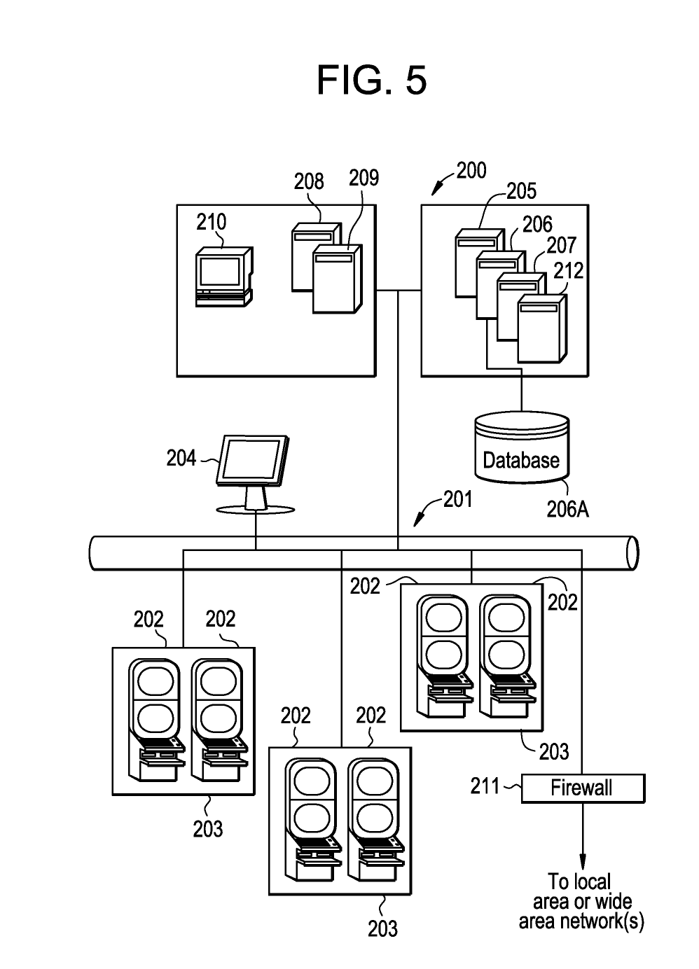

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere, and data indicative of symbols, prize amounts and symbol functions used in the game.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 3, the peripheral devices that communicate with the game controller 101 include one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted depending on the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106,107,108,109,110,111 may be provided remotely from the game controller 101.

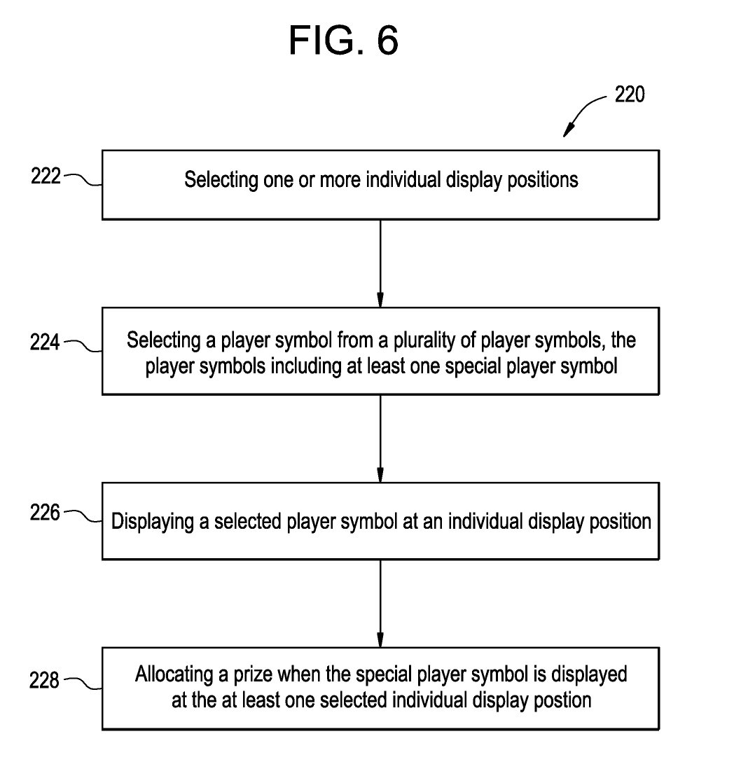

FIG. 5 shows a gaming system 200 in accordance with an alternative embodiment. The gaming system 200 includes a network 201, which for example may be an Ethernet network, a LAN or a WAN. In this example, three banks 203 of two gaming machines 202 are connected to the network 201. The gaming machines 202 provide a player operable interface and may be the same as the gaming machines 40, 100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

A loyalty program server 212 may also be provided.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

An example of a specific implementation of the gaming system will now be described in relation to a stand alone gaming machine 40, 100, although it will be understood that implementation may also be carried out using other gaming system architectures such as a network architecture of the type shown in FIG. 5.

In the present embodiment, the gaming system 10 is arranged to display virtual symbols using a video graphical display device, although it will be understood that other arrangements are envisaged, such as reels with the symbols disposed thereon. The symbols in this example are in the form of representations of dice numbers.

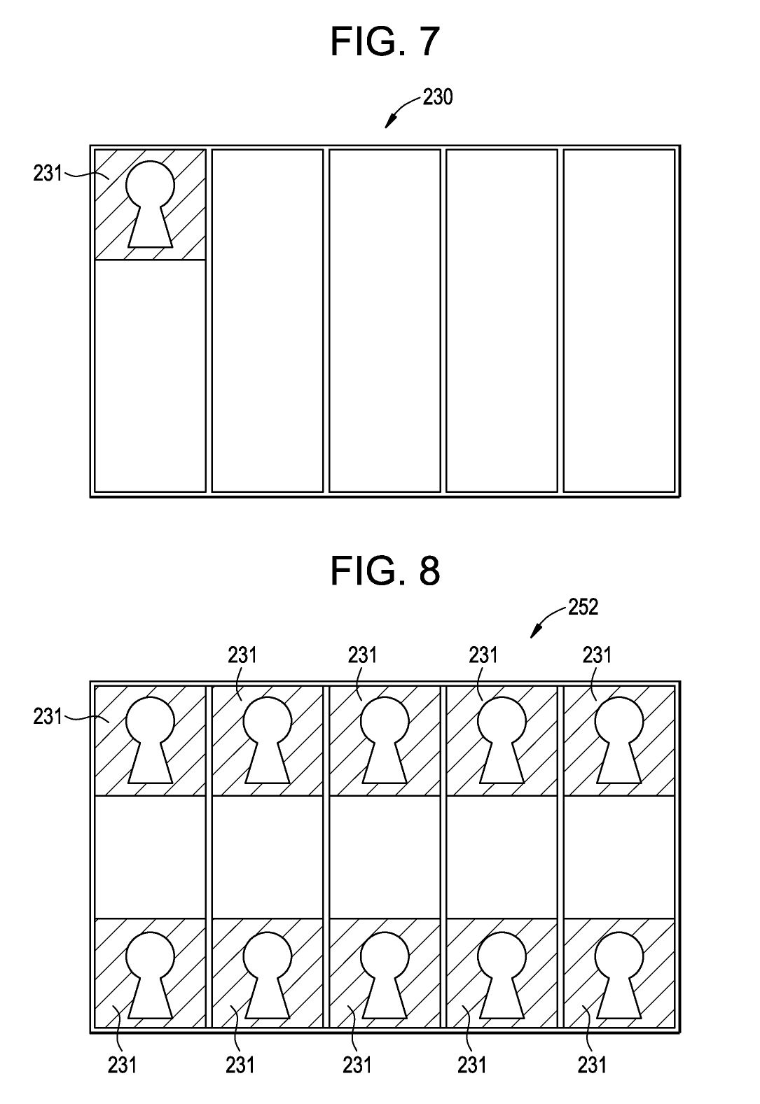

FIG. 6 shows a method 220 of gaming according to a specific embodiment of the present invention. The method includes step 222 of selecting one or more individual display positions by the player. For example, the individual display positions may be selected on the display 46 of the gaming machine 40 shown in FIG. 2.

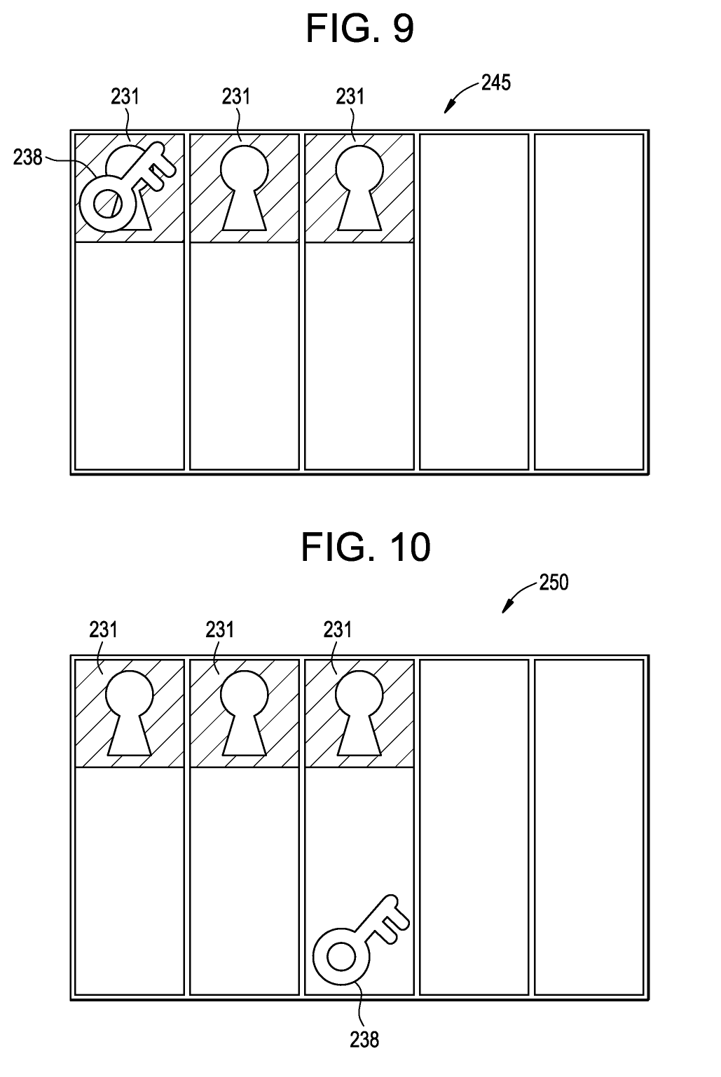

FIGS. 7 and 8 schematically show such displays. The shown displays have 15 individual display positions which are ordered in an array of five columns and three rows. A person skilled in the art will appreciate that alternatively the display may have any other number of display positions ordered in any other way.

The display 230 shown in FIG. 7 includes a selection indicator 231, which in this example is provided in the form of a keyhole symbol positioned at the selected individual display position. In this embodiment, the player has the option to purchase one or more of such selections for credits. Further, the player has the option to select which ones of the individual display positions he wishes to select. The display 230 illustrates the case that only one individual position is selected.

FIG. 8 shows a display 252 in which a total of 10 display positions are selected and the selections are displayed in the form of key-hole selection indicators 231. In a variation of the described embodiment, the gaming system may also be arranged so that a player has the option to determine how many individual display positions should be selected, but the gaming system may be arranged to select the locations for the individual display positions that are selected.

The method 220 also includes the step 224 of selecting a player symbol (or a number of player symbols) from a plurality of player symbols. The plurality of player symbols includes at least one special player symbol. The selected player symbol is then displayed at an individual display position (step 226).

FIG. 9 shows a schematic display in which three individual display positions are selected and the selection is displayed in the form of a key-hole selection indicator 231. Further, a special player symbol 238 is displayed at one of the selected positions and a prize will be allocated.

The method 220 may include selecting one player symbol for each individual display position and displaying the selected player symbols at respective display positions. Alternatively, one or more of the individual display positions may be left blank.

The display 245 shows only one selected player symbol. It is to be appreciated by a person skilled in the art that alternatively any number of player symbols may be selected and displayed. Further, only player symbols other than the special player symbols may be selected (randomly) and displayed.

FIG. 10 shows a schematic display 250 in which also three individual display positions are selected by the player and the selections are displayed by the keyhole symbol 231. However, in this case a special player symbol is displayed at an individual display position that is not selected.

The player is typically given the option to select win lines. For example, the top and bottom rows of the display positions of display 252 may be such win lines selected by the player. The gaming system typically is arranged so that winning combinations of player symbols are displayed at display positions along such win lines.

The method 220 also includes the step 228 of allocating a prize when the special player symbol is displayed at least one selected position. For example, the prize may be a Jackpot prize, such as a progressive Jackpot prize.

It is to be appreciated by a person skilled in the art that the present invention may be embodied in many different forms. For example, the gaming system may be arranged so that the player symbols only include special player symbols that are displayed at selected ones of the individual display positions while other display positions may be left blank. Further, the selection of the at least one individual display position may be displayed using any suitable symbol or may alternatively not be displayed or may be displayed at a remote location.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments and/or aspects without departing from the spirit or scope of the invention as broadly described. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming system comprising:
a player symbol selector arranged to select player symbols from a plurality of player symbols, the plurality of player symbols including at least one special player symbol;
a display having a plurality of individual display positions for displaying at least one selected player symbol;
a display position selector for selecting at least one individual display position prior to displaying a selected player symbol at that display position; and
a prize allocator for allocating a prize when the at least one special player symbol is displayed at least one selected individual display position.

2. The gaming system of claim 1 wherein the display position selector is controllable by a player so that the player can select the at least one individual display position.

3. The gaming system of claim 1 wherein the gaming system is arranged so that the display position selector randomly selects an individual display position from a group of individual display positions upon activation by a player.

4. The gaming system of claim 1 wherein the selection of the individual display position is associated with a purchase by a player.

5. The gaming system of claim 1 wherein the prize allocator allocates a Jackpot prize when the at least one special player symbol is displayed at least one selected individual display position.

6. The gaming system of claim 1 wherein the gaming system is arranged so that the chance to win a Jackpot prize is proportional to the number of selected individual display positions.

7. The gaming system of claim 1 wherein the special player symbol is a player symbol that is displayed at an individual display position in addition to another player symbol displayed at that position.

8. The gaming system of claim 1 wherein the gaming system is arranged so that only one player symbol is displayed at each individual display position.

9. The gaming system of claim 1 wherein the gaming system is arranged so that a prize is won when a combination of winning player symbols is displayed along a win line.

10. The gaming system of claim 1 wherein the gaming system is arranged for selecting a plurality of individual display positions along a win line.

11. The gaming system of claim 1 wherein the gaming system is arranged so that the location of the at least one selected individual display position is indicated.

12. The gaming system of claim 1 wherein the gaming system is arranged so that the location of the at least one selected individual display position is displayed by displaying a selection indicator at the position of the at least one individual display position.

13. The gaming system of claim 12 wherein the special player symbol and the at least one selection indicator are associated with each other.

14. A method of gaming comprising:
selecting at least one player symbol from a plurality of player symbols, the plurality of player symbols including at least one special player symbol;
displaying at least one selected player symbol at one of a plurality of individual display positions;
selecting at least one individual display position prior to displaying the selected player symbol; and
allocating a prize when the at least one special player symbol is displayed at least one selected individual display position.

15. The method of claim 14 wherein allocating a prize comprises allocating a Jackpot prize.

16. The method of claim 14 wherein selecting comprises selecting the at least one individual display position by a player.

17. The method of claim 16 wherein selecting comprises purchasing a selection of the at least one individual display position.

18. The method of claim 14 wherein selecting comprises selecting the at least one individual display position using a selector that randomly selects the at least one individual display position from a group of display positions.

19. The method of claim 14 wherein displaying comprises displaying the at least one special player symbol at least one selected individual display position in addition to another player symbol displayed at that position.

20. The method of claim 14 wherein displaying comprises displaying only one player symbol at each individual display position.

21. The method of claim 14 further comprising selecting at least one win line.

22. The method of claim 21 wherein selecting comprises selecting the at least one individual display position along the at least one win line.

23. The method of claim 14 wherein the method is conducted so that the chance to win a Jackpot prize is proportional to the number of selected individual display positions.

24. The method of claims 14 comprising displaying at least one selection indicator that marks the selection of the at least one selected individual display position.

25. The method of claim 24 wherein the selection indicator is displayed at the at least one selected individual display position.

26. The method of claim 24 wherein the special player symbol and the at least one selection indicator are associated with each other.

27. A computer readable medium including a computer program instructing a computer and arranged so that, when loaded in the computer, the computer operates as a gaming system comprising:
a player symbol selector arranged to select player symbols from a plurality of player symbols, the plurality of player symbols including at least one special player symbol;
a display having a plurality of individual display positions for displaying at least one selected player symbol;
a display position selector for selecting at least one individual display position prior to displaying a selected player symbol at that display position; and
a prize allocator for allocating a prize when the at least one special player symbol is displayed at least one selected individual display position.

28. A computer that is arranged for operation in accordance with a gaming system comprising:
a player symbol selector arranged to select player symbols from a plurality of player symbols, the plurality of player symbols including at least one special player symbol;
a display having a plurality of individual display positions for displaying at least one selected player symbol;
a display position selector for selecting at least one individual display position prior to displaying a selected player symbol at that display position; and
a prize allocator for allocating a prize when the at least one special player symbol is displayed at least one selected individual display position.
